(19) United States
(12) Patent Application Publication
(10) Pub. No.: US 2004/0121760 A1
(43) Pub. Date: Jun. 24, 2004

(54) Authentication in a communication system

(76) Inventors: Illkka Westman, Helsinki (FI); Valtteri Niemi, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/475,826

(22) PCT Filed: Apr. 4, 2002
(86) PCT No.: PCT/IB02/01155

(30) Foreign Application Priority Data
Apr. 25, 2001 (SE) 0110188.0

(51) Int. Cl. H04M 1/66

(52) U.S. Cl. 455/411

(57) ABSTRACT

A communication system comprises two authentication entities. A first authentication entity (24) is for authentication of a registration request by a user (1). The first authentication entity is provided with a storage means for authentication data associated with the user. A second authentication entity (22) is for authentication of a further request by the user. The second authentication entity is provided with means for requesting data associated with the user from the first authentication entity. The second entity may also comprise means for storing user data communicated from the first entity. The provision of the user data from the first entity to the second entity may occur while the user is in an inactive state. The further request may comprise a session set-up request.

### FIELD OF THE INVENTION

The present invention relates to authentication procedures in a communication system.

### BACKGROUND OF THE INVENTION

A communication system can be seen as a facility that enables communication between two or more entities such as user equipment and/or other nodes associated with the system. A communication system typically operates in accordance with a given standard or specification which sets out what the various elements of the system are permitted to do and how that should be achieved. For example, the standard or specification may define if the user, or more precisely, user equipment or terminal is provided with a circuit switched service and/or a packet switched service. Communication protocols and/or parameters which shall be used for the connection may also be defined. In other words, a specific set of “rules” on which the communication can be based on needs to be defined to enable communication by means of the system.

Communication systems proving wireless communication for the user terminals or other nodes are known. An example of the wireless systems is a cellular network. In cellular systems, a base transceiver station (BTS) or similar access entity serves mobile stations (MS) or similar wireless user equipment (UE) via a wireless interface between these entities. The operation of the base station apparatus and other apparatus required for the communication can be controlled by one or several control entities. The various control entities may be interconnected. One or more gateway nodes may also be provided for connecting the cellular network to other networks. e.g. to a public switched telephone network (PSTN) and/or other communication networks such as an IP (Internet Protocol) and/or other packet switched networks.

A communication system may be adapted to provide wireless data communication services such as packet switched (PS) services for a mobile station. Examples of systems enabling wireless data communication services, without limiting to these, include the General Packet Radio Service (GPRS), the Enhanced Data rate for GSM Evolution (EDGE) mobile data network, the third generation (3G) telecommunication systems such as the Universal Mobile Telecommunication System (UMTS), i-phone or IMT-2000 (International Mobile Telecommunications) and the Terrestrial Trunked Radio (TETRA) system.

For example, in the current third generation (3G) multimedia network architectures it is assumed that several different servers are used for handling different functions. These include functions such as the call state control functions (CSCFs). The call state function may comprise functions such as a proxy call state control function (P-CSCF), interrogating call state control function (I-CSCF), and serving call state control function (S-CSCF). The serving call state control can be divided further between originating call state control function (O-CSCF) and terminating call state control function (T-CSCF) at the originating and terminating ends of a session. Control functions may also be provided by entities such as a home subscriber server (HSS) and various application servers.

From the above mentioned servers the home subscriber server (HSS) is for storing subscriber related information. The subscriber information may include authentication data such as registration identities (ID) of the subscriber or the terminals and so on. The home subscriber server (HSS) can be queried by other function entities, e.g. during session set-up procedures. It shall be appreciated that the term “session” refers to any communication such as to a call, data (e.g. web browsing) or multimedia communication and so on.

At least some degree of authentication may be required in a communication system. A request for a service such as for registration, session and so on may, for example, be rejected or accepted based on the outcome of an authentication procedure. After the authentication procedure a predefined procedure will follow, depending on the request and application and the outcome of the authentication.

The following will discuss authentication proceedings and related problems with reference to an internet protocol (IP) based third generation (3G) communication system and session initiation protocol (SIP). However, it shall be appreciated that the following description is given in order to illustrate the disadvantages associated with the present proposals and not to limit the description to these examples. Instead, the following description shall be understood to be a general description of the authentication procedures and problems associated with the prior art systems in this regard.

A service request or similar may originate from a user equipment in communication with an access entity of the communication system. The communication between the user equipment and the elements of the communication network is based on an appropriate communication protocol such as the session initiation protocol (SIP). During authentication proceedings various authentication queries or messages and authentication parameters such as those based on authentication quintets and/or keys may be transferred between the entities involved in the process.

For example, SIP request messages such as those that associate with registration or re-registration of a user equipment (e.g. the so called REGISTER and re-REGISTER messages) typically require authentication in order to prevent unauthorised access by third parties. Messages that associate with the session set-up procedures of already registered user equipment such as the so called INVITE message and so on may also need to be authenticated. The authentication of the session set-up request may, however, not be required every time but may be accomplished e.g. every fifth message or so.

The authentication of said requests has been proposed to be accomplished in a common network element that is located at the home network of a subscriber. In accordance with the current proposals the authentication shall be done either in the home subscriber server (HSS) or in the serving call state control function (S-CSCF). However, the inventors have found that use of a common authentication entity for these two different request may not be appropriate in all occasions.

The session set-up messages could be authenticated at the S-CSCF. The session set-up message such as an INVITE message may be transferred to the S-CSCF from a visited P-CSCF, that is from a proxy call state control function of the own (home) or another network. The set-up message may alternatively arrive from an I-CSCF if the so called network configuration hiding is used.

However, if the S-CSCF is used for the authentication, the following steps may be required before a REGISTER message can be authenticated at the S-CSCF:

1) A home subscriber server (HSS) needs to be queried to get advice which S-CSCF to choose;

2) a REGISTER message needs to be sent to the chosen S-CSCF; and

3) the chosen S-CSCF may need to fetch subscriber information from the HSS in order to be able to authenticate the REGISTER message.

The step No. 3) may not be needed if the same information could be fetched during the step 1) and could be subsequently sent to the S-CSCF at step 2). However, a possible service attack may continue during through out this procedure and may generate a mass of false REGISTER messages that are transported from the I-CSCF to the S-CSCF in accordance with the above steps 1 to 3. This is so since the I-CSCF cannot filter out the unauthorised registration request but transfers them all to the serving call state control function for authentication. As explained above, the inventors have found that it may be too late to authenticate a reguest such as the REGISTER message at the S-CSCF.

If the home subscriber server (HSS) is used for the authentication the home subscriber server (HSS) may not be able to authenticate all session set-up requests. The HSS cannot authenticate e.g. all SIP INVITE messages because these messages have not necessarily been passed to the serving controller entity through the I-CSCF or other similar entity capable of querying authetication parameters from the HSS chat may be required in the authentication process. To force all set-up requests to pass an I-CSCF entity that queries authentication parameters every time from the HSS adds the load of the I-CSCF and the HSS. This may also make the set-up process slower because of the additional signaling.

### SUMMARY OF THE INVENTION

Embodiments of the present invention aim to address one or several of the above problems.

According to one aspect of the present invention, there is provided a communication system comprising: a first authentication entity for authentication proceedings in association with registration requests by a user, the first authentication entity being provided with authentication data associated with the user; and a second authentication entity for authentication proceedings in association with session related requests by the user, the second authentication entity being provided with means for requesting data associated with the user from the first authentication entity.

According to another aspect of the present invention there is provided an authentication method for a communication system, comprising: receiving from a user a request for registration; authenticating said registration request by means of a first authentication entity based on user data stored at the first authentication entity; communicating user data from the first authentication entity to a second authentication entity; receiving from the user a further request; and authenticating said further request by means of the second authentication entity and said user data communicated from the first authentication entity.

In a more specific embodiment the second authentication entity requests for said user data when the user is off-line. The second authentication entity may also be adapted to request for said user data only after the request for registration has been authenticated. The second authentication entity may be provided with storage means for storing user data received from the first authentication entity.

Said user data may comprise at least one authentication vector.

The registration request may comprise a register message or a re-register message generated by a user equipment for a 3G data communication system. The further request may comprise a session set-up request. The session set-up request may comprise invite messages generated by a user equipment of a 3G data communication system.

The embodiments of the invention may provide an authentication procedure wherein denial of service attacks associated with registering messages are quickly noticed. The inventors have also found it possible to authenticate set-up messages such as the INVITE messages at a separate controller entity than where e.g. the registering messages are authenticated. The authentication of the set-up messages by means of a home subscriber data processing entity is made possible also in instances wherein the set-up messages do not pass an interrogating call state function. The authentication prosedure may become simpler and quicker by distributing the authetication procedure in a plurality of network elements. The key elements of the controller entities may be less and more evenly loaded because of distributed authentication proceedings.

### BRIEF DESCRIPTION OF DRAWINGS

For better understanding of the present invention, reference will now be made by way of example to the accompanying drawings in which:

FIG. 1 shows a communication system architecture wherein the present invention can be embodied;

FIGS. 2 and 3 show information flows in accordance with an embodiment of the present invention; and

FIG. 4 is a flowchart illustrating the operation of one embodiment of the present invention.

### DESCRIPTION OF PREFERRED EMBODIMENTS OF THE INVENTION

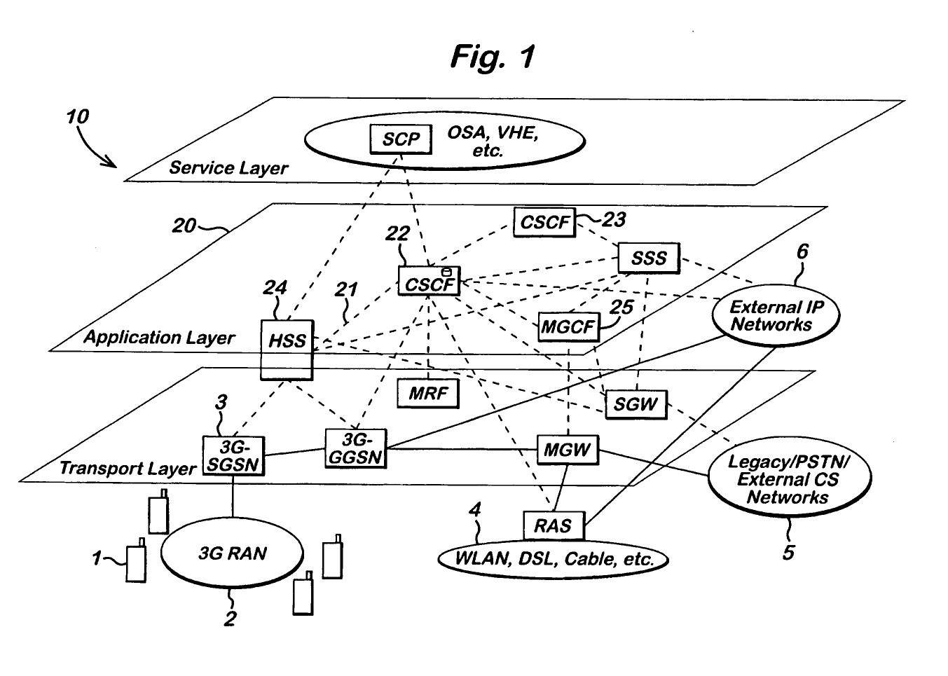

Reference is first made to FIG. 1 which shows a possible network system architecture wherein the present invention may be embodied. The exemplifying network system 10 is arranged in accordance with UMTS 3G specifications. The cellular system 10 is divided between a radio access network (RAN) 2 and a core network (CN).

In general terms, it is possible to describe a communication system as a model in which the functions of the system are divided in several hierarchically arranged function layers. FIG. 1 shows three different function layers, i.e. a service layer, an application layer and a transport layer and the positioning of various network elements relative to these layers. It shall be appreciated that the layered model is shown only in order to illustrate the relationships between the various functions or a data communication system. In a physical i.e. real implementation the entities (e.g. servers or other nodes) are typically not arranged in a layered manner.

A plurality of user equipment 1 is served by a 3G radio access network (RAN) 2 over a wireless interface. Hence the user equipment will be referred to in the following by the term mobile station. The radio access network function is hierarchically located on the transport layer. It shall be appreciated that although FIG. 1 shows only one radio access network for clarity reasons, a typical communication network system comprises a number of radio access networks.

The 3G radio access network (RAN) 2 is shown to be physically connected to a serving general packet radio service support node (SGSN) entity 3. The SGSN 3 is a part of the core network. In the functional model the entity 3 belongs to the transport layer. The operation of a typical cellular network and the various transport level entities thereof is known by the skilled person and will thus not be explained in more detail herein.

An application layer 20 is shown to be located on top of the transport layer. The application layer 20 may include several application level functions. FIG. 1 shows two call state control entities (CSCFs) 22 and 23. From these the call state server 22 is the so called serving call state control function (S-CSCF). That is, the server 22 is currently serving at least one of the mobile stations 1 and is in control of the status of said at least one mobile station.

The application layer is also shown to comprise a home subscriber server (HSS) entity 24. The home subscriber server (HSS) 24 is for storing the registration identities (ID) and similar user related information.

For the sake of completeness some other elements such as various gateway entities (e.g. the Media Gateway Control Function MGCF, Media Gateway MGW and the Signalling Gateway SGW) are also shown. However, these do not form an essential part of the invention and will thus not be described in any great detail.

The solid lines indicate actual data communication between various entities. The dashed lines indicate signalling traffic between various entities. The signalling is typically required for management and/or control functions, such as for registration, session set-up, charging and so on. As can be seen, user equipment 1 may have communication via the access network 2 and appropriate gateways with various other networks such as networks 4, 5 and 6. The other networks may be adapted to operate in accordance with any appropriate standard.

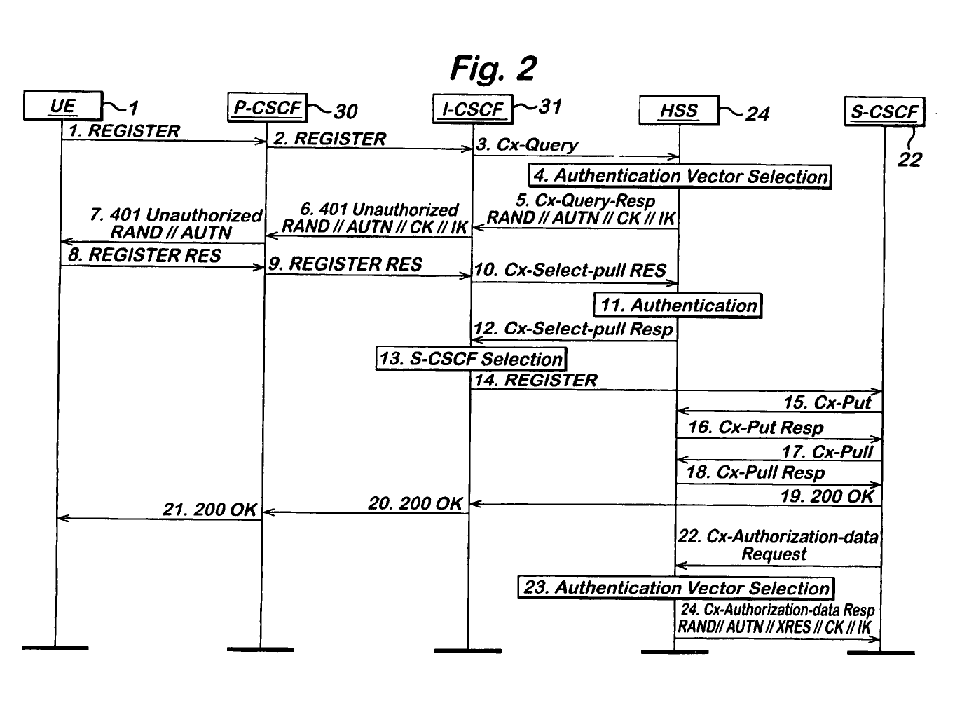

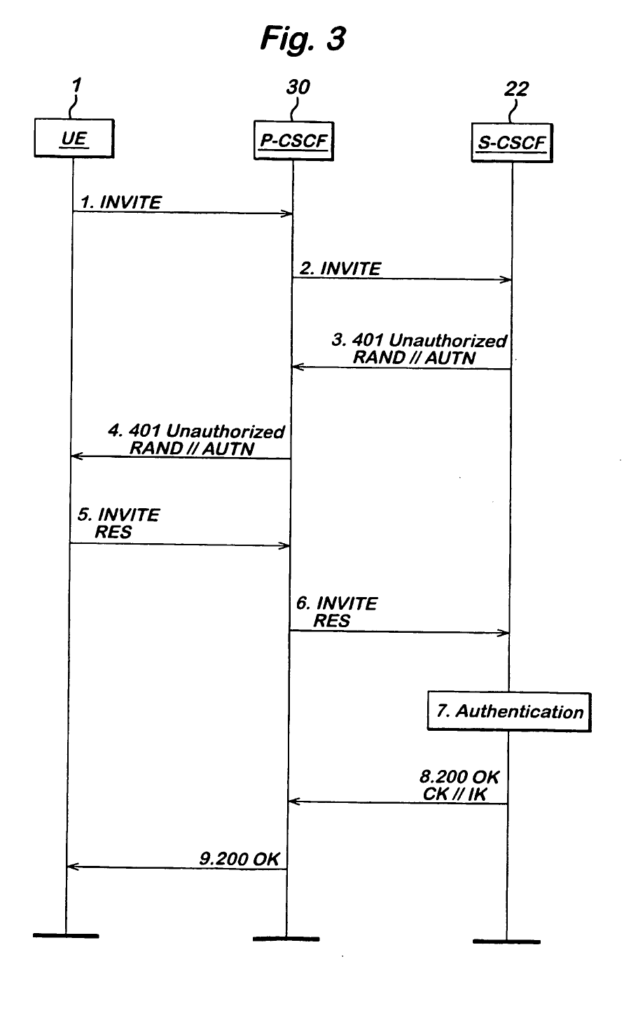

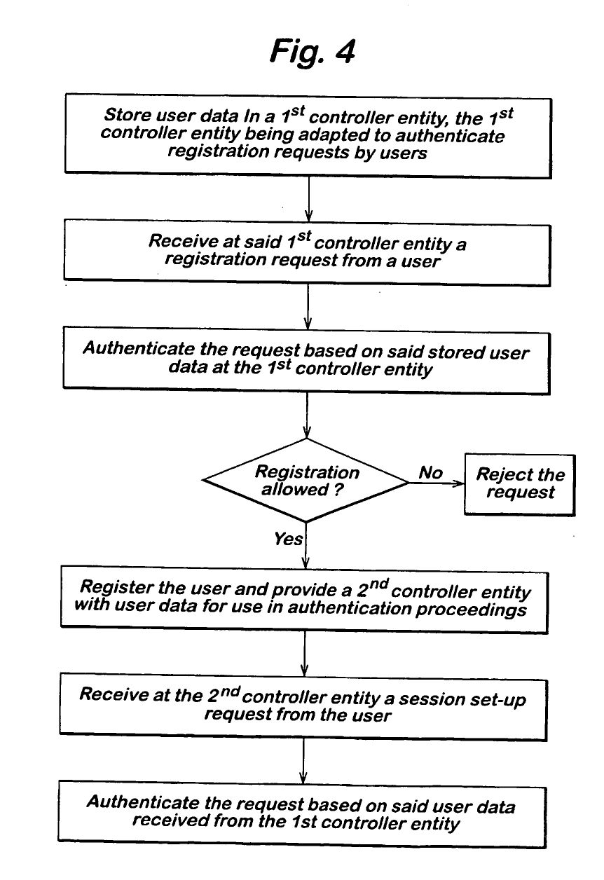

In the embodiments described with reference to FIGS. 2 to 4 different authentication functions are distributed between different network entities. In a preferred embodiment the authetication function is divided between the home subscriber server (HSS) 24 and the serving call state control function (S-CSCF) 22. More particularly, authentication for registration requests (REGISTER) is done at the HSS 24. Authentication for session set-up requests (INVITE) is done at the S-CSCF 22. FIGS. 2 and 3 shows possible information flows associated with authentication o: registration and session set-up requests, respectively.

More particularly, FIG. 2 shows signalling flows for a situation wherein a user 1 generates and sends a register request (1.) to a proxy call state controll function entity 30. The proxy controller 30 forwards (2.) the request to an interrogating call state control function (I-CSCF) entity. An interrogating call state control function (I-CSCF) entity may be included between the home network control entity such as the HSS 24 and the proxy controller entity 30 e.g. in applications where network configuration hiding feature is used. However, it shall be understood that the intermediate controller entity 31 is not required in all applications embodying the present invention.

The I-CSCF may then query (3.) for authentication data such as authentication vectors from the HSS 24. For example, the I-CSCF 31 can ask from the HSS 24 for authentication quintets such as RAND, AUTN, RES, CK, IK and so on. The vectors are selected by the HSS (4.) and returned (5.) in response to the controller entity 31 I-CSCF. The I-CSCF then forwards the vectors (6.) to the proxy controller entity 30. The ‘401 Unauthorised’ message acts as an indication that the registration requested by the user equipment 1 needs to be authenticated. This message may contain parameters such as the RAND and AUTN which are needed for authentication purposes in the user equipment 1. The proxy controller entity 30 may then transmit an authentication message (7.) with appropriate parameters to the user equipment 1.

The user equipment 1 checks the AUTN parameter, computes the authentication response RES and sends RES in an appropriate register message (8.) to the P-CSCF 30. The P-CSCF forwards the message (9.) with the parameter RES to the I-CSCF 31. The I-CSCF 31 then transmits the message further (10.) with the parameter RES to the HSS 24.

The HSS 24 may authenticate (11.) the user equipment 1 e.g. by checking if the received value RES and the value of the so called XRES parameter stored in the HSS are equal. If so the user 1 is successfully authenticated. The I-CSCF 31 may then request for registration of the user equipment 1 by a registration request message (14.).

During the registration the S-CSCF and HSS may exchange a set of Cx-Put and Cx-Pull requests and responses (messages 15. to 18.). At the end the S-CSCF indicates to the I-CSCF that the registration was successfully completed by sending an OK message (19.). The I-CSCF may then forward the received message (20.) to the P-CSCF. The P-CSCF forwards the OK to the user 1 (21.).

It shall be appreciated the FIG. 2 signalling may be used to autheticate any message that arrives the intermediate controller entity 31.

As mentioned above, all session set-up messages are not necessarily passed through an I-CSCF entity or similar controller entity arranged between the proxy control function 30 and the home subcriber server (HSS) 24. Thus the HSS 24 may not always be an appropriate entity for authentication of session set-up requests. Instead of this, as show by FIG. 3, the session set-up request could be more appropriately accomplished at the serving call state control function entity 22. On the other hand, the authentication of the registration request should be done at the HSS 24 in order to improve the protection against access by unauthorised users. Therefore, in order to avoid the “too late” authentication of the registration messages at the S-CSCF 22 the authentication procedures are divided between the HSS and S-CSCF entities so that the respective messages can be authenticated as soon as it is possible.

In order to address this the S-CSCF 22 may be adapted to fetch a batch of authentication vectors from the HSS 24 as soon as registration of a mobile station 1 has taken place. This can be done via the signalling connection 21 between the entities 22 and 24 of FIG. 1. The fetching procedure is also shown by steps 22 to 24 in FIG. 2. It shall be appreciated that the fetching of authentication data can also be accomplished in other stages, such as between stages 18 and 19 or between the steps 16 and 17 of FIG. 2.

The S-CSCF 22 can ask from the HSS 24 for authentication quintets such as the RAND, AUTN, RES, CK, IK parameters. The quintets may be asked in batches, say, batches of five. The query may be accomplished as an off-line query as regards the user-affected procedures.

The S-CSCF 22 is adapted to store the fetched authentication data. Based on the authentication vectors it is then possible for the S-CSCF 22 to authenticate session set-up requests by the mobile station 1 directly without making any further on-line queries to the HSS 24.

One or more of the messages 3, 5, 10 and 12 of FIG. 2 can be replaced with specialised authentication messages. The replaced messages of 3, 5, 10 and 12 may be moved without any authentication parameters between actions 12 and 13 of FIG. 2. The result of actions 4 and 23 may or may not be the same i.e. the authentication vector is or is not the same in both cases. The message (24.) may or may not contain XRES depending on whether it is needed by the S-CSCF.

FIG. 3 shows authentication of the session set-up request in a situation wherein the required authentication data has already been fetched from HSS 24 and is thus available at the serving controller entity 22.

The user 1 generates and sends an INVITE message (1.) to a proxy controller entity 30. The proxy entity 30 forwards the message (2.) to the serving controller entity 22 S-CSCF. The S-CSCF then sends to the proxy controller entity 30 a ‘401 Unauthorised’ message (3.). This message is forwarded at action step (4.) to the user 1. This message acts as an indication that the request by the user 1 needs to be authenticated. The message may contain parameters such as the RAND and AUTN which may be needed for authentication purposes in the user 1.

The user equipment 1 checks appropriate parameters, computes an authentication response RES and sends the RES in an appropriate INVITE message (5.) to the P-CSCF 30. The P-CSCF forwards the message (6.) with to the S-CSCF 22. The S-CSCF 22 then authenticates (7.) the user 1. If the user 1 is successfully authenticated the S-CSCF may then send OK (8.) to the P-CSCF. The P-CSCF 30 may then forward the OK to the user 1 (9.).

It shall be appreciated that the above described method may also be used for other purposes that for authentication of session initiation messages (e.g. the INVITE messages). The method can be used to authenticate whichever messages (e.g. any other SIP methods) that bypasses an intermediate controller entity such as the I-CSCF entity and arrives a serving controller entity such as the S-CSCF entity.

A request for registration can be sent whenever a user equipment wants to register to a network, e.g. whenever a user equipment is turned on or whenever the user equipment roams from a service area of a network into the service area of another network. A registration may be required e.g. periodically or whenever there is a need to authenticate the already existing registration of a user equipment.

It shall be appreciated that whilst embodiments of the present invention have been described in relation to mobile stations, embodiments of the present invention are applicable to processing authentication for any suitable type of users.

It shall also be appreciated that a network may comprise a plurality of various controller entities, such as a plurality of I-CSCF or S-CSCF entities or HSS entities. Furthermore, the user may be registered to a home network or a visited network.

The embodiment of the present invention has been described in the context of the UMTS 3G system and session initiation protocol (SIP). This invention is also applicable to any other communication systems and protocols.

It is also noted herein that while the above describes exemplifying embodiments of the invention, there are several variations and modifications which may be made to the disclosed solution without departing from the scope of the present invention as defined in the appended claims.

1. A communication system comprising:
a first authentication entity for authentication proceedings in association with registration requests by a user, the first authentication entity being provided with authentication data associated with the user; and
a second authentication entity for authentication proceedings in association with session related requests by the user, the second authentication entity being provided with means for requesting data associated with the user from the first authentication entity.

2. A communication system as claimed in claim 1, wherein the second authentication entity is adapted to request for said user data when the user is off-line.

3. A communication system as claimed in claim 1 or 2, wherein the second authentication entity is adapted to request for said user data after the request for registration has been authenticated.

4. A communication system as claimed in any preceding claim, wherein the second authentication entity is provided with storage means for storing user data received from the first authentication entity.

5. A communication system as claimed in any preceding claim, wherein said user data comprises at least one authentication vector.

6. A communication system as claimed in any preceding claim, wherein the requests are based on the session initiation protocol (SIP).

7. A communication system as claimed in any preceding claim, wherein the registration requests comprise register messages or a re-register messages generated by a user equipment for a 3G data communication system.

8. A communication system as claimed in any preceding claim, wherein the session related requests comprise session set-up requests.

9. A communication system as claimed in claim 8, wherein the session set-up requests comprise invite messages generated by a user equipment of a 3G data communication system.

10. A communication system as claimed in any preceding claim, wherein the first authentication entity and the second authentication entity are provided in the home network of the user.

11. A communication system as claimed in claim 10, wherein the user is visiting another network at the time of sending a request to be authenticated.

12. A communication system as claimed in any preceding claim, wherein the first authentication entity is provided in association with a home subscriber server entity of the user.

13. A communication system as claimed in any preceding claim, wherein the second authentication entity is provided in association with a serving call state control function.

14. A communication system as claimed in any preceding claim, comprising at least one proxy controller entity, at least one intermediate controller entity, and at least one serving controller entity.

15. A communication system as claimed in any preceding claim, wherein the user comprises a station adapted for wireless communication with at least one station of the communication system.

16. An authentication method for a communication system, comprising:
receiving from a user a request for registration;
authenticating said registration request by means of a first authentication entity based on user data stored at the first authentication entity;
communicating user data from the first authentication entity to a second authentication entity;
receiving from the user a further request; and
authenticating said further request by means of the second authentication entity and said user data communicated from the first authentication entity.

17. A method as claimed in claim 16, wherein the user data is communicated between the first and second authentication entities regardless the status of the user.

18. A method as claimed in claim 16 or 17, comprising receiving a plurality of further requests and subjecting only a certain portion of said further requests to authentication proceedings.

19. A method as claimed in any of claims 16 to 18, wherein the further request comprises a request for a session.
